(19) United States
(12) Patent Application Publication
(10) Pub. No.: US 2004/0217219 A1
(43) Pub. Date: Nov. 4, 2004

(54) Food grater

(76) Inventors: Anthony Di Bitonto, Brooklyn, NY (US); Arsenio Garcia, Brooklyn, NY (US); Kevin Lozeau, Ridge, NY (US)

Correspondence Address: SEYFARTH SHAW, 55 EAST MONROE STREET, SUITE 4200, CHICAGO, IL, 60603-5803, US

(21) Appl. No.: 10/428,369

(22) Filed: May 2, 2003

(51) Int. Cl. A47J 43/25

(52) U.S. Cl. 241/95

(57) ABSTRACT

A food grater is provided having a grater blade which is removably attached to a base using a latching mechanism to quickly and securely secure the grater blade to the base. The base includes resilient pads thereon to provide for a gripping surface that functions as a handle to easily operate the food grater, including use of a pouring spout formed at an end of the base.

The present invention pertains to a kitchen utensil and in particular a food grater for grating cheese and other foods.

### BACKGROUND

Graters for grating food items such as cheese or chocolate are known to have a removable grater blade attached to a housing. For example, graters are known that have ball shaped engagement lugs formed on the grater blade which are received by projecting ears formed on the housing. Other attachment means are known where the grater blade may slide along channels formed on the housing. Such attachment methods may not maintain the grater blade securely and may allow for movement of the blade during a grating operation. As the grating blade is exposed to many strong grating forces, acting in multiple directions during the grating operation, the securement of the grating blade to the housing in a secure and non-vibrating fashion is important. Therefore, it is desired to provide a latching means which not only securely attaches the grating blade to the housing, but also allows for the grating blade to be easily removed from the housing.

Other grater devices are known that include additional components attached to the housing that form a handle or other means of grasping the grater. The addition of multiple components, such as a separate handle, adds to the cost and assembly time of such devices. Such graters include housings that may collect the grated food product and enable measurement of such grated product collected in the housing. Graters are also known that have gripping pads attached in order to aid in gripping the grating device. However, there is desired a grater which includes a housing that provides for easy gripping, pouring, grating, and removal of the grater blade.

### SUMMARY

The present invention provides for a food grater comprising a grater blade including multiple grating teeth, a detachable base including a food storage cavity having a first end having a spout, a pad attached to the base and a latching member for attaching grater blade to the base, wherein the base may be grasped by a user's hand so that a user's finger may grip the pad in order to operate the food grater. In an embodiment, the grater may further comprise a pair of resilient gripping pads attached to the base. In an embodiment, the base may include a pair of sides extending between the first and second ends. In an embodiment, the pair of resilient gripping pads may be attached to the sides adjacent the frame to provide gripping surfaces for the user's hand or fingers. In an embodiment, the base may include a second end having a flat surface for standing the base upright.

In an embodiment, the spout may be formed integrally with the first end and is semi-circular in shape. In an embodiment, the latching member may include a tab extending from the frame that may be received by a receptacle formed on the base. In an embodiment, the latching member may include a tab extending from the base that may be received by a receptacle formed on a frame of the grater blade. In an embodiment, the latching member may include a pair of hooks extending from an edge of a frame that may be received by a corresponding aperture formed in the base. In an embodiment, the frame may be formed separate from the blade and may include an opening for receiving the blade therein.

In an embodiment, the latching member may include a generally U-shaped tab having a proximal end connected to the main body and a distal end having a resilient finger. In an embodiment, a frame is provided that may include a receptacle having a latching rim for receiving the resilient finger. In an embodiment, the latching rim may be flexible so that upon abutment of the resilient finger against the latching rim, the latching rim and resilient finger will flex in opposite directions, allowing the resilient finger to slide past the latching rim so that the finger may orient in a latched position. In an embodiment, the resilient finger may have a nub that protrudes behind the latching rim in order to latch the resilient finger within the receptacle and mount the frame to the base. In an embodiment, a pivotal latching assembly including a hook may protrude from the grater blade and may be received by an aperture at the second end of the base allowing for the pivotal mounting of the grater blade to the base when the hook is received in the aperture. In an embodiment, a latching member may be provided at the first end of the base so that when the frame is pivoted, by the hook received within the aperture, the latching member may engage the grater base and latch the base to the grater blade. In an embodiment, the frame may include measuring indicia for quantifying the volume of food received within the cavity.

In an embodiment, the frame may be formed of a translucent material. In an embodiment, the frame may be formed of a clear polymer material. In an embodiment, the base may include a hole adjacent the latching member and the grater blade may include a post that may be inserted in the hole when the grater blade is attached to the base. In an embodiment, the post may help to align the grater blade to the base so that the latching member aligns within the receptacle. In an embodiment, the resilient pad may be overmolded onto the base. In an embodiment, the resilient pad may be formed of a thermoplastic elastomer. In an embodiment, the blade may be removably mounted to a frame. In an embodiment, the base may form a handle to the be gripped by a user's hand in order to operate the grater. In an embodiment, the frame may include an opening and the grater blade is mounted within the opening.

The present invention further provides for a method of assembling a food grater comprising the steps of providing a base having a latching member at a first end, an aperture at a second end and a resilient pad attached at a side, inserting a hook protruding from a grater blade frame into the aperture, pivoting the grater blade frame to enclose an open side of the base and latching the grater blade frame to the base by engaging the latching member to a receptacle of the grater blade frame.

### BRIEF DESCRIPTION OF THE DRAWINGS

For the purpose of facilitating an understanding of the subject matter sought to be protected, there is illustrated in the accompanying drawings an embodiment thereof, from an inspection of which, when considered in connection with the following description, the subject matter sought to be protected, its construction and operation, and many of its advantages should be readily understood and appreciated.

FIG. 1 is an exploded, perspective view of the food grater of the present invention;

FIG. 2 is a top plan view of the food grater of FIG. 1;

FIG. 3 is a front end view of the food grater of FIG. 1;

FIG. 4 is a rear end view of the food grater of FIG. 1;

FIG. 5 is a bottom plan view of the food grater of FIG. 2;

FIG. 6 is a side elevation view of the food grater of FIG. 1; and

FIG. 7 is an enlarged sectional view taken at line 7-7 in FIG. 2.

### DETAILED DESCRIPTION

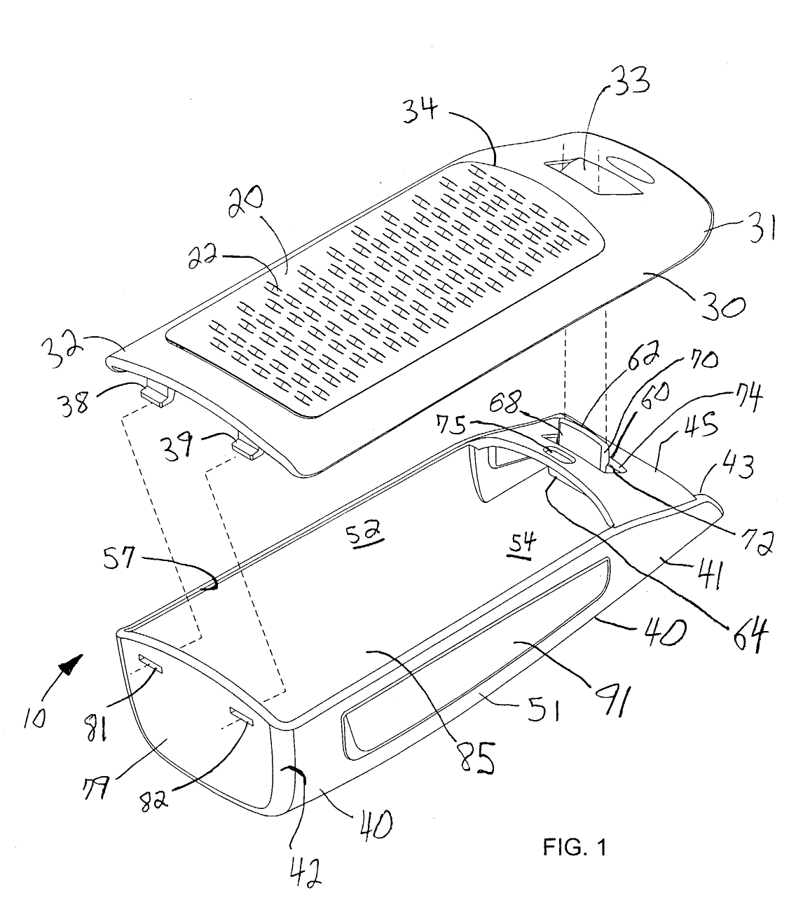

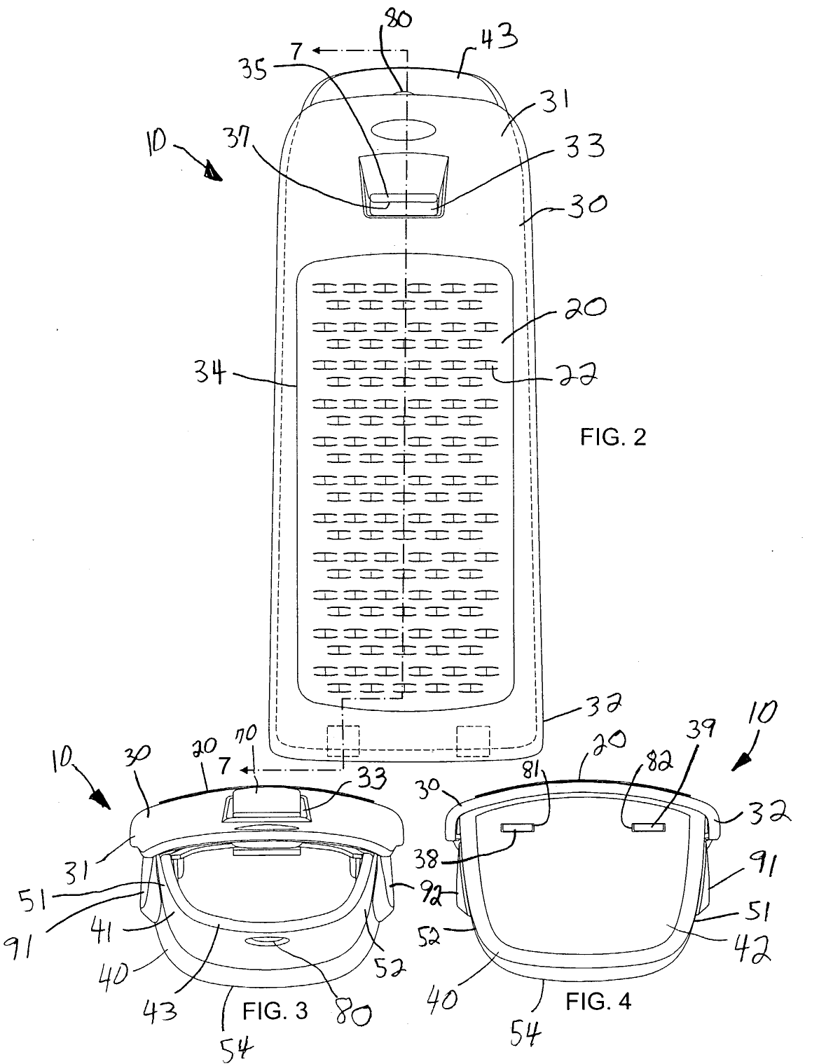

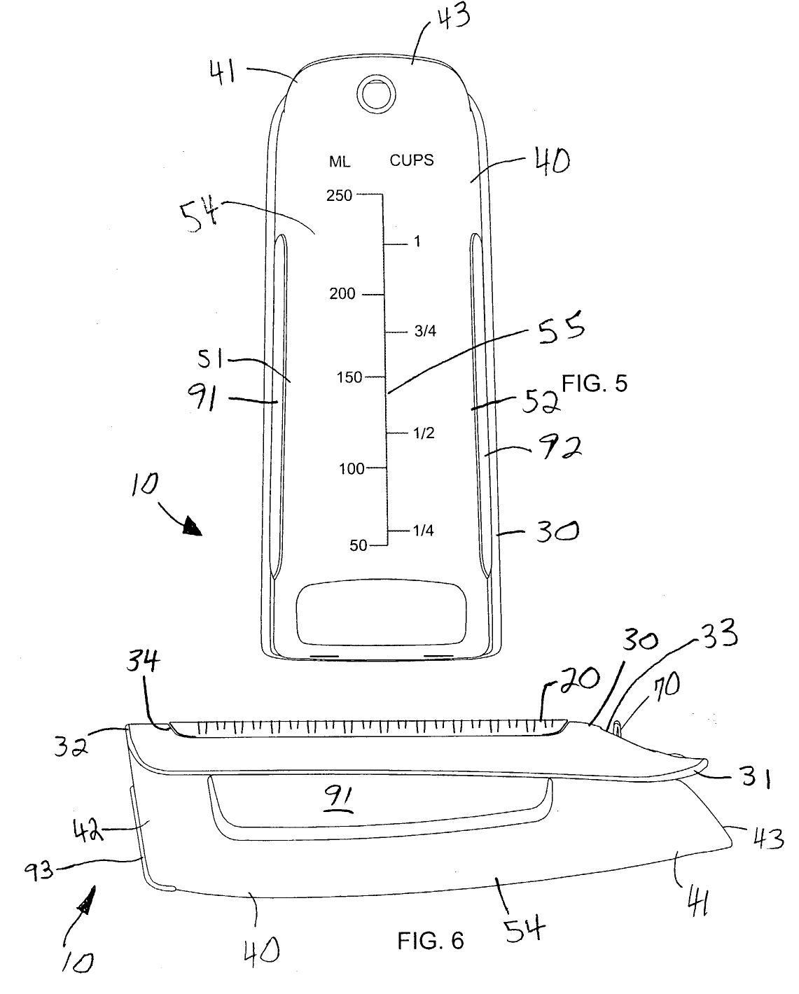

An embodiment of the present invention is described with reference to FIGS. 1-7. A food grater 10 is provided having a grater blade 20 having multiple grating teeth 22 formed thereon. In an embodiment the grater blade 20 is stainless steel and the grating teeth 22 are stamped therein and chemically etched. In an embodiment, the grater blade 20 is mounted to a frame 30. In an embodiment, the frame 30 is formed of zinc and, in an embodiment, is chrome plated. However, in an alternate embodiment the frame 30 and grater blade 20 may be formed as a single grater blade unit. The frame 30 includes a first end 31 and a second end 32. Formed at the first end 31 is a receptacle 33. The receptacle 33 includes a latching rim 35 and an edge 37. The second end 32 of the frame 30 includes a pair of hooks 38, 39. In an embodiment, the hooks 38, 39 are L-shaped and are formed of zinc or cast aluminum. The frame 30 includes an opening 34 into which is received the grater blade 20. In an embodiment the grater blade 20 is attached to the frame 30 by press-fitting the edges of the grater blade 20 within the opening 34. In an alternate embodiment, the grater blade 20 may also be attached to the frame 30 by snap-locking edges, heat staking, and/or insert molding the grater blade 20 to the frame 30.

The frame 30 is removably attached to a base 40. The base 40 includes a first end 41 and a second end 42. The first end 41 of the base 40 includes a spout 43. In an embodiment, the spout is integrally formed with the base 40 and forms a semi-circular shaped opening through which the grated food may be poured. In other embodiments, the spout may be attached to the base 40 and have other shapes. In an embodiment, the base 40 may be formed of a polymer material, for example, clear polycarbonate or ABS. In an embodiment, the spout 43 may be molded as one piece with the rest of the base 40. The first end 41 of the base 40 also includes a bridge 45. The bridge 45 is formed between a first lateral side 51 and a second lateral side 52. In an embodiment, the base 40 forms a generally U-shape, where the lateral sides 51, 52 have a curved surface that forms each edge of a back or bottom side 54 of the base 40. In an embodiment, the back side 54 includes measuring indicia 55, for example, indicating the volume of food received within the base 40. For example, measurement markings between ¼ cup and 1 cup and 50 and 250 milliliters may be embossed on the back side 54. Other marking means may be used to apply the indicia 55 to the base 40. The preferred embodiment of the base 40 is formed of a translucent or clear material. Thus, as the food item fills the base 40, it can be viewed through the back side 54 so that the measuring indicia 55 can be used to quantify the volume of food grated into the base 40.

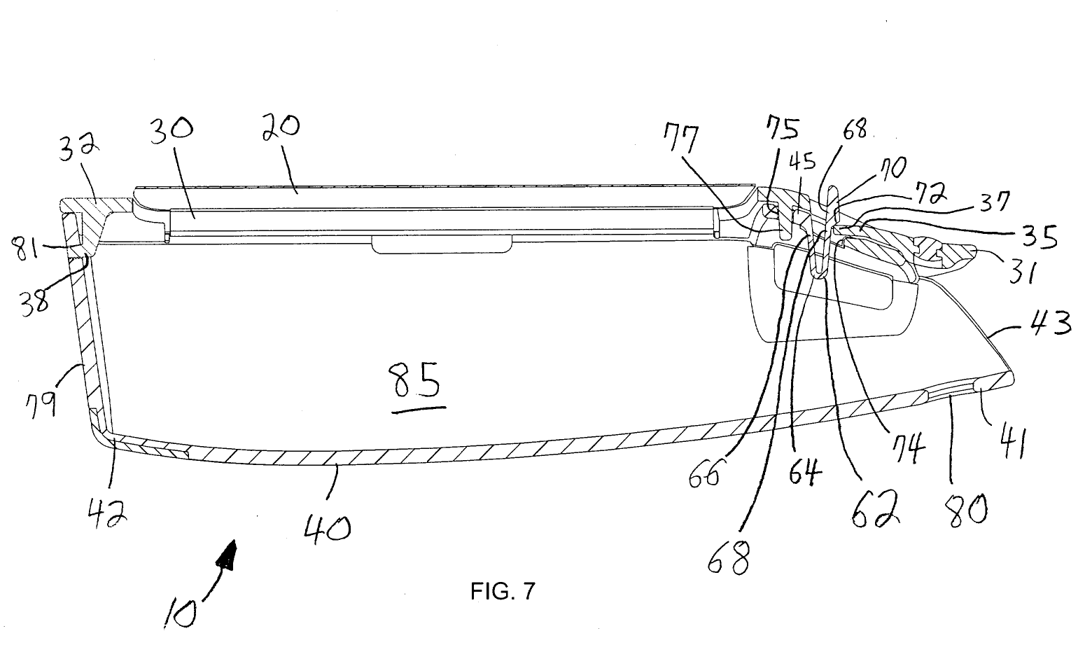

In an embodiment, the bridge 45 also forms one edge of an open side 57. The open side 57 is also formed by each lateral side 51, 52 and the second end 42 of the base 40 (see FIG. 1). In an embodiment, the open side 57 receives the frame 30 and grater blade 20 mounted thereon, as will be discussed further below. The bridge 45, in an embodiment, includes a latching mechanism 60, which includes a latching member 62 formed generally as a U-shaped tab 64 (see FIG. 7), having a proximal end 66 which is attached to the bridge and a distal end 68 that includes a resilient finger 70 having a nub 72 formed thereon. The distal end 68 of the latching member 62 is located within an aperture 74. In an embodiment, the latching member 62 is formed of a polymer material which provides for flexibility and resilience of the member 62 so that it may flex laterally within the aperture 74 when latching occurs. In an embodiment, the latching member 62 is molded as one piece with the bridge 45. Also formed on the bridge 45 is a hole 75, formed adjacent to the latching mechanism 60. In an embodiment, the hole 75 receives a post 77 that protrudes from the frame 30. The post 77 helps to align the frame 30 with the base 40 in order for the latching mechanism 60 to latch with the receptacle 33 of the frame 30. In an alternate embodiment, the latching member may be on the frame and the receptacle on the base. In a further alternate embodiment, the post may be on the base and the hole on the frame.

In an embodiment, a bore 80 may be formed adjacent the edge of the spout 43. In an embodiment, the bore 80 may be used to hang the food grater 10 on a hook or for receiving a string therethrough in order to hang the food grater 10. In an embodiment, the bore 80 is small enough so that when food is poured through the spout 43, the bore 80 will not impede the food's egress.

The second end 42 of the base 40 is formed as a flat planar surface 79, in an embodiment. The flat surface 79 will allow for the base 40 to be stood on its end on a support surface (not shown) such as a countertop, so that the food grater 10 need not be held continuously in a user's hand. The flat surface 79 at the second end 42 has a pair of slots 81, 82 formed therein for receiving the hooks 38, 39, respectively therein. In an alternate embodiment, the hooks may be on the base and the slots on the frame.

Therefore, it may be understood that the lateral sides 51, 52, second end 42 and the back side 54 form a generally four sided container, which forms a food storage cavity 85. Formed on each lateral side 51, 52 is a pad 91, 92 respectively. In an embodiment, pads 91, 92 respectively extend longitudinally along the majority of the length of lateral sides 51, 52 of the base 40. Each pad 91, 92 is formed generally adjacent the open side 57 of the base 40. In an embodiment, each pad 91, 92 is formed of a resilient, flexible material. In an embodiment, the pads 91, 92 are attached to the base 40 by overmolding. In an embodiment, each pad is formed of a polymer material, for example, a thermoplastic elastomer. The formation of the base 40, having a curved back side 54 and having the pads 91, 92 on each lateral side 51, 52, respectively, provides for a base 40 which generally forms a handle which may be easily grasped by a user's hand. For example, if the user is “right-handed” the user will grip the base 40 so that his/her thumb is abutting pad 91 and his/her other fingers abut pad 92. The food grater 10 may then be easily operated by grating a food item against the grater blade 20. The base 40 also includes a pad 93 formed at the second end 42 (see FIG. 6). The pad 93 helps to grip a horizontal surface upon which the food grater 10 is placed with the flat surface 79 parallel thereto, so that the grater is upright and the blade 20 is perpendicular to a horizontal surface or counter. Upon scraping of a food item against the blade 20, the pad 93 will absorb the grating force against the blade 20 and will help to prevent the food grater 10 from sliding on the horizontal surface. In an embodiment, the pad 93 is formed by overmolding thermoplastic elastomer on the second end 42 of the base 40. In an alternate embodiment, a pad may be formed at an end of the frame 30, for example at the first end 31.

The assembly of the food grater, in an embodiment, is as follows. The frame 30 is provided adjacent to the open side 57 of the base 40. The frame 30 is tilted so that the hooks 38, 39 are moved towards the second end 42 of the base 40. The hooks 38, 39 are moved downward into the open side 57 so that each hook 38, 39 is aligned with the slots 81, 82, respectively. The second end 32 of the frame 30 is then slid downward toward the second end 42 of the base 40 so that the hooks 38, 39 are received completely within the slots 81, 82, respectively. The frame 30 is then pivoted so that the first end 31 of the frame 30 is rotated downward toward the first end 41 of the base 40. Upon rotation and pivoting of the frame 30, the frame 30 and grater blade 20 assembly will enclose the open side 57 of the base 40.

As the frame 30 is continued to be rotated, enclosing the open side 57, the post 77 is received by the hole 75 provided on the bridge 45 of the base 40. The insertion of the post 77 into the hole 75 helps to align the frame 30 over the open side 57 so that the sides of the frame 30 are aligned with the sides 51, 52 of the base 40 and also so that the latching mechanism 60 is aligned to the receptacle 33 of the frame 30. Latching of the frame 30 to the base 40 occurs by the resilient finger 70 abutting the edge 37 of latching rim 35 of the receptacle 33 (see FIG. 7). The resilient finger 70 is formed as part of the U-shaped tab 64 which is resilient. The latching rim 35 is also formed so that it may flex upward, upon abutment by the resilient finger 70. As the frame 30 and base 40 are continued to be moved together, the finger 70 slides past the edge 37, causing both the latching rim 35 and distal end 68 of the U-shaped tab 64 to flex and move away from each other. As the finger 70 is moved up and through the receptacle 33, the nub 72 of the finger 70 will slide past and engage the edge 37 so that the latching rim 35 may relax and return to its static position, abutting the bridge surface 45. The distal end 68 of the U-shaped tab 64 will regain its static position so that it is latched above the edge 37 of the latching rim 35 and the nub 72 engages the edge 37 (as shown in FIG. 7). In an embodiment, this latching operation of the nub 72 engaging the edge 37 will provide a “snap” sound, upon the full engagement of the latching member 62 within the receptacle 33. Although other embodiments may be provided, having other types of latching mechanisms, it is desirable for the latching mechanism to provide secure attachment of the frame 30 and grater blade 20. For example, the latching member 62 and hooks 38, 39 act to securely fasten the frame 30 and grater blade 20 to the base 40, so that during vigorous grating motions, the frame 30 will not become removed or vibrate improperly during operation of the food grater 10.

As well, after the grating operation is completed, the latching mechanism 60 allows for the frame 30 to be easily removed. A user's finger is placed on the distal end 68 of the U-shaped tab 64 on the resilient finger 70. By pushing the distal end 68 towards the proximal end 66 so that the nub 72 is moved away from the edge 37, the latching member 62 is disengaged. Using the same hand that delatches the latching member 62, the user may grasp the sides of the frame 30 and pull it away from the frame 40, while the resilient finger 70 is depressed (by the user's index finger) and orientated within the receptacle 33. Upon complete removal of the resilient finger 70 from the receptacle 33, due to the pivoting of the frame 30 and separating the first end 31 of the frame 30 from the first end 41 of the base 40, the frame 30 may then be completely separated from the base 40 by removing the hooks 38, 39 from the slots 81, 82, respectively. This operation of attaching and detaching the frame 30 and grater blade 20 to and from the base 40 is accomplished more easily due to the assembly and construction of the base having the pads 91, 92 formed on the lateral sides 51, 52 and having the entire back side 54 of the base formed as a handle so that the base 40 is easily grasped while the latching mechanism 60 is operated.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A food grater comprising:
a grater blade including multiple grating teeth;
a detachable base including a food storage cavity having a first end having a spout;
a pad attached to the base; and
a latching member for attaching the grater blade to the base, wherein the base may be grasped by a user's hand so that a user's finger may grip the pad in order to operate the food grater.

2. The food grater of claim 1 wherein the grater further comprises a pair of resilient gripping pads attached to the base.

3. The food grater of claim 2 wherein the base includes a pair of sides extending between the first end and second end.

4. The food grater of claim 3 wherein the pair of resilient gripping pads are molded to the sides adjacent the frame to provide gripping surfaces for the user's hand or fingers.

5. The food grater of claim 1 wherein the base includes a second end having a flat surface for standing the base upright and a pad attached at the flat surface.

6. The food grater of claim 1 wherein the spout is formed integrally with the first end.

7. The food grater of claim 1 wherein the latching member includes a tab extending from the grater blade and received by a receptacle formed on the base.

8. The food grater of claim 1 and further comprising a frame to which the grater blade is attached, wherein the latching member includes a tab extending from the base and received by a receptacle formed on a frame of the grater blade.

9. The food grater of claim 1 wherein the grater blade is attached to a frame and the latching member includes a pair of hooks extending from an edge of the frame and the hooks are received by corresponding apertures formed in the base.

10. The food grater of claim 9 wherein the frame is formed separate from the blade and includes an opening for receiving the blade therein.

11. The food grater of claim 1 wherein the latching member includes a generally U-shaped tab having a proximal end connected to the base and a distal end having a resilient finger.

12. The food grater of claim 11 wherein the grater blade includes a frame having a receptacle having a latching rim for receiving the resilient finger.

13. The food grater of claim 12 wherein the latching rim is flexible, so that upon abutment of the resilient finger against the latching rim, the latching rim and resilient finger will flex in opposite directions, allowing the resilient finger to slide past the latching rim and the finger and orient in a latched position.

14. The food grater of claim 13 wherein the resilient finger has a nub that protrudes beyond the latching rim in order to latch the resilient finger within the receptacle so that the frame is mounted to the base.

15. The food grater of claim 1 further comprising a pivotal latching assembly including a hook protruding from the grater blade that is received by an aperture at the second end of the base that provides for the pivotal mounting of the grater blade to the base when the hook is received in the aperture.

16. The food grater of claim 15 wherein a latching member is provided at the first end of the base so that when the grater blade is pivoted by the hook received within the aperture, the latching member engages the grater blade and latches the base to the frame.

17. The food grater of claim 1 wherein the base includes measuring indicia for quantifying the volume of food received within the food storage cavity.

18. The food grater of claim 1 wherein the base is formed of a translucent material.

19. The food grater of claim 1 wherein the base is formed of a clear polymer material.

20. The food grater of claim 1 the base includes a hole adjacent the latching member and the grater blade includes a post to be inserted in the hole when the grater blade is attached to the base.

21. The food grater of claim 20 wherein the post is arranged to align the grater blade to the base and so that the latching member aligns within a receptacle.

22. The food grater of claim 1 wherein the pad is overmolded onto the base.

23. The food grater of claim 22 wherein the pad is formed of a thermoplastic elastomer.

24. The food grater of claim 1 further comprising a frame and the blade is removably mounted to the frame.

25. The food grater of claim 24 wherein the frame includes an opening and the grater blade is mounted within the opening.

26. The food grater of claim 1 wherein the base forms a handle to be gripped by a user's hand in order to operate the grater.

27. A method of assembling a food grater comprising the steps of:
providing a base having a latching member at a first end, an aperture at a second end and a resilient pad attached at a side;
inserting a hook protruding from a grater blade into the aperture;
pivoting a grater blade frame to enclose an open side of the base; and
latching the grater blade to the base by inserting the latching member into a receptacle of the grater blade.

28. The method of claim 27 further comprising the step of mounting the grater blade to a frame.

29. The method of claim 27 further comprising the steps of gripping the resilient pad of the base with a first hand and gripping the grater blade with a second hand and moving the grater blade toward the base in order to detachably mount the grater blade and base together.

30. The method of claim 27 further comprising the steps of detaching the grater blade from the base by:
depressing the latching member;
pivoting the grater blade away from the base;
removing the latching member from the receptacle; and
removing the hook from the aperture.
